(19) United States
(12) Patent Application Publication
(10) Pub. No.: US 2009/0250939 A1
(43) Pub. Date: Oct. 8, 2009

(54) WIND-DRIVEN GENERATION OF POWER

(76) Inventor: Oliver D. Curme, Weston, MA (US)

Correspondence Address: FISH & RICHARDSON PC, P.O. BOX 1022, MINNEAPOLIS, MN, 55440-1022, US

(21) Appl. No.: 12/420,568

(22) Filed: Apr. 8, 2009

Related U.S. Application Data
(60) Provisional application No. 61/043,327, filed on Apr. 8, 2008.
(60) Provisional application No. 61/043,333, filed on Apr. 8, 2008.

(51) Int. Cl. F03D 9/00; F16C 19/00; F03D 11/00

(52) U.S. Cl. 290/55; 384/445; 416/1; 416/169 R

(57) ABSTRACT

Among other things, for wind-driven generation of electricity, a main shaft is rotated by a wind-driven rotor. A wheel having a diameter of at least 5 meters is mounted to rotate with the main shaft. An electrical generator is driven by the wheel. A yaw ring defines a plane around which the main shaft and rotor yaw. The wheel intersects the plane of the yaw ring.

### CROSS-REFERENCE TO RELATED APPLICATIONS

This application claims the benefit of U.S. Provisional Application No. 61/043,327, filed Apr. 8, 2008 and U.S. Provisional Application No. 61/043,333, filed Apr. 8, 2008, the entire disclosures of which are incorporated by reference herein.

### BACKGROUND

This description relates to wind driven generation of power.

Typical large wind turbines, for example, are mounted on tall monopole towers to take advantage of higher wind velocities at higher altitudes. Monopole towers are strong and considered aesthetically pleasing. The top of a monopole is typically small, requiring care in balancing the nacelle and rotor. A strong bearing connects the nacelle to the tower to allow yaw of the turbine around a vertical axis. (We sometimes use the term wind turbine to refer to any device that uses wind to generate electricity.)

Rotary electrical interfaces, such as slip rings that include rotating conductive bands wiped by stationary contacts or brushes, are often used to make electrical connections to sensors and control systems in the wind turbine rotor.

### SUMMARY

In general, in an aspect, for use in wind-driven generation of electricity, a main shaft is rotated by a wind-driven rotor. A wheel having a diameter of at least 5 meters is mounted to rotate with the main shaft. An electrical generator is driven by the wheel. A yaw ring defines a plane around which the main shaft and rotor yaw. The wheel intersects the plane of the yaw ring.

Implementations may include one or more of the following features, among others. The electrical generator is driven by the wheel by direct engagement of gear teeth. There are at least nine electrical generators to be driven by the wheel. The apparatus can generate at least one megawatt, and the average power of the generators is less than 200 kilowatts. At least one other wheel is mounted to rotate with the shaft, and there is another electrical generator to be driven by the other wheel. A braking disk is mounted to rotate with the main shaft. A brake is mounted stationary relative to the main shaft and configured to engage the braking disk. There are at least 50 generators to be driven by the wheel. The speedup ratio between the main shaft and the generator is at least 50 in a single speedup stage. Bearings (e.g., at least three bearings) support the main shaft. The largest distance between two bearings along the main shaft is at least 10 meters.

At least two carriages support the main shaft on the yaw ring and permit the main shaft to yaw about a vertical axis. The wheel and the generator lie completely within an imaginary vertical cylinder that is centered on the vertical axis and has a diameter equal to an outer diameter of the yaw ring. The yaw ring has a diameter of at least 10 meters, or at least 5 meters. The main shaft has an access portal to allow a person to pass through the main shaft to a hub of the wind-driven rotor. There is a nacelle structure and two additional carriages support the nacelle structure on the yaw ring. The yaw carriages include wheels to engage the yaw ring. The yaw ring includes structure to restrain vertical movement of the carriages relative to the yaw ring. The yaw ring includes structure to restrain horizontal movement of the carriages. The nacelle structure encloses the main shaft and the generator. The nacelle structure includes a lattice. There is a lightweight covering on the lattice.

In general, in an aspect, a bull gear is mounted on a shaft to be driven by a bladed rotor. The bull gear includes segments that can be disassembled for shipment and reassembled for installation. The bull gear has gear teeth at its periphery to directly drive at least one electric generator with no intervening gear stages.

Implementations may include one or more of the following features, among others. The diameter of the bull gear is at least 5 meters. There are teeth are on an outer peripheral surface of the bull gear that is parallel to the shaft. The teeth are on a surface of the bull gear that is perpendicular to the main shaft. A pinion gear associated with the electric generator has teeth to be driven directly by the gear teeth of the bull gear. The pinion gear includes a resilient element to absorb torque ripple of the generator and reduce teeth wear. The pinion gear drives at least one other generator. A mechanism selectively disengages the generator from being driven by the wheel. The mechanism includes a clutch. The mechanism is operated electrically. The mechanism is operated hydraulically. The bull gear achieves a speed-up ratio of at least 50 from rotation of the shaft driven by the bladed rotor to rotation of a shaft of the generator. The gear teeth are formed on sections that can be disassembled for shipment and reassembled for installation. The gear teeth sections include features to interlock the teeth sections when they are mounted on the bull gear.

In general, in an aspect, a bull gear is temporarily assembled from segments. An outer periphery of the temporarily assembled bull gear is machined to be circular and continuous. The segments are disassembled for shipment to a wind tower site and reassembled at the site. Gear teeth sections are attached on the bull gear during reassembly.

Implementations may include one or more of the following features, among others. During reassembly, a final gear teeth section is attached to the bull gear before a final one of the bull gear segments is installed. Each gear teeth section has interlocking features to interlock adjacent gear teeth sections when they are mounted on the bull gear.

In general, in an aspect, a main shaft that is supported between at least two bearings and has an end that extends beyond one of the bearings to be driven by a bladed rotor. A power generator is mounted to the main shaft and rotates with it, being driven against the stationary nacelle. A nacelle holds the main shaft and power generator. The power generator is driven by the main shaft against a mechanism that is stationary with respect to a nacelle. Power transmission lines connect the power generator to a powered system within the bladed rotor without requiring a slip ring or similar device.

Implementations may include one or more of the following features, among others. The power generator includes an electrical generator or a hydraulic or pneumatic pump. The power transmission lines are at least partly within the main shaft. The powered system adjusts a pitch of a blade connected to the rotor, or powers lights on the blades, or powers sensors on the hub or the blades.

In general, in an aspect, a main shaft is rotated by a wind-driven rotor. A main wheel is mounted to rotate with the main shaft. The generator shaft includes a feature that engages the main wheel to drive an electrical generator. The ratio of the diameter of the main wheel to the diameter of the feature of the generator shaft is 50 or greater.

Implementations may include one or more of the following features, among others. The generator shaft includes a generator wheel. The generator shaft includes gear teeth to engage gear teeth at a periphery of the main wheel. There are at least nine electrical generators to be driven by the main wheel. The apparatus can generate at least one megawatt, and the average power of the generators is less than 200 kilowatts. At least one other wheel is mounted to rotate with the shaft, and another electrical generator is driven by the other wheel.

In general, in an aspect, a wheel is mounted to rotate with the main shaft at a location separate from the rotor hub and a mechanism selectively decouples the wheel from rotation with the main shaft.

Implementations may include one or more of the following features, among others. The mechanism to selectively decouple the wheel from rotation with the main shaft includes a clutch. Among the advantages of this design is the large degree of speed up between the main shaft and the generators in a single gear stage. The generators can be driven directly by the pinion gear or there can be additional gear stages with each generator or pair of generators to increase the speed still further. Each pair of gears need not take the entire torque generated by the rotor, but only take the rotor torque divided by the number of generators. For example, a 5 megawatt turbine with 200 pinions can have the gears sized to 25 kilowatts each, which is far less than the power in an automobile. Low cost materials and manufacturing methods can be used. The potentially large number of generators required per turbine lends itself to lowering costs through mass manufacturing methods.

In an aspect, at least three legs define a lower tower that is relatively broad at its lower end and rises to a relatively narrow waist. A nacelle support is relatively narrow at its lower end where it is attached to the waist and relatively broader at its upper end where it supports the nacelle. A main shaft is rotated by a wind-driven rotor. A wheel is mounted to rotate with the main shaft at a location separate from a hub of the rotor. An electrical generator is driven by the wheel. A yaw ring is on the nacelle support. The yaw ring defines a plane around which the main shaft and rotor yaw. The wheel intersects the plane of the yaw ring.

These and other aspects and features, and combinations of them can be expressed as methods, apparatus, systems, program products, business methods, and means for performing functions, and in other ways.

Other advantages and features will become apparent from the following description and from the claims.

### DESCRIPTION

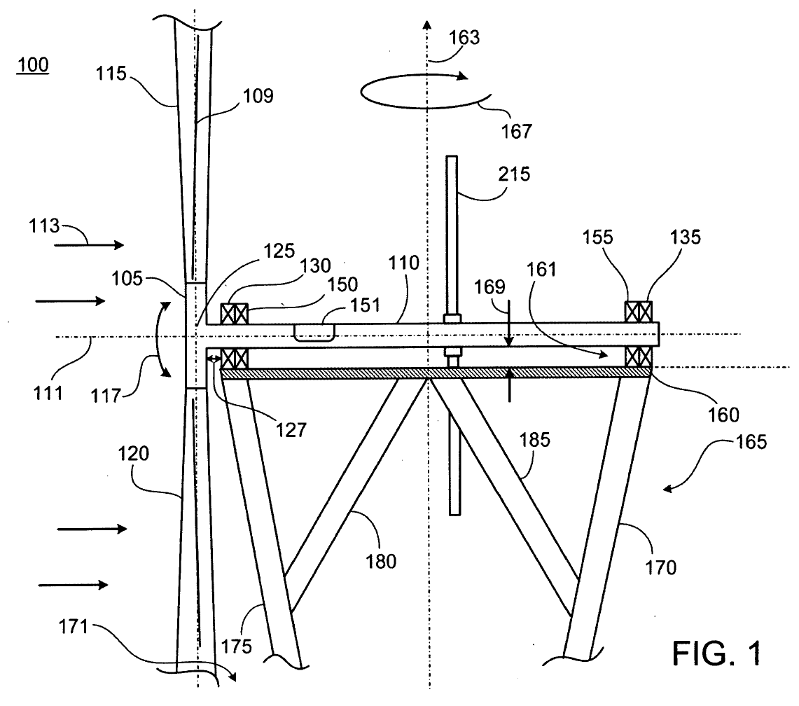

FIG. 1 is a schematic side view of part of a wind turbine on a support tower.

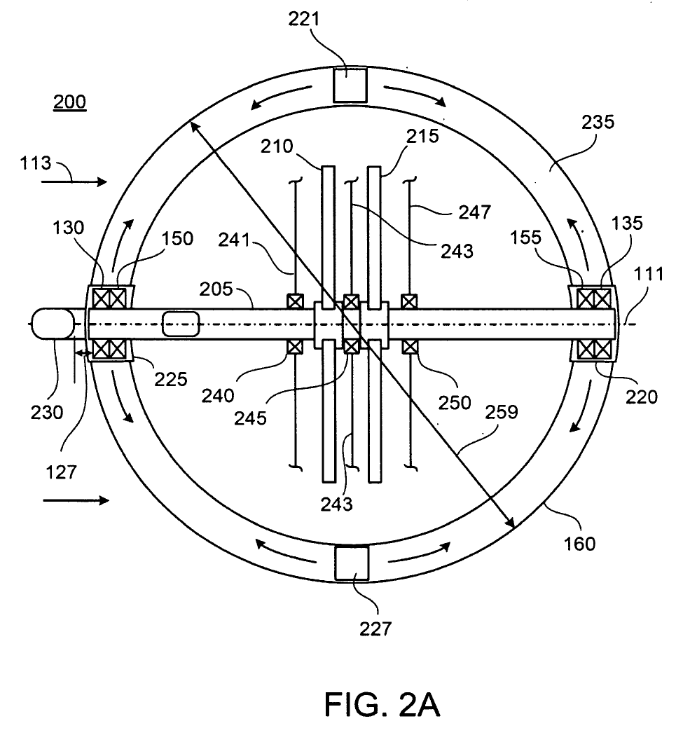

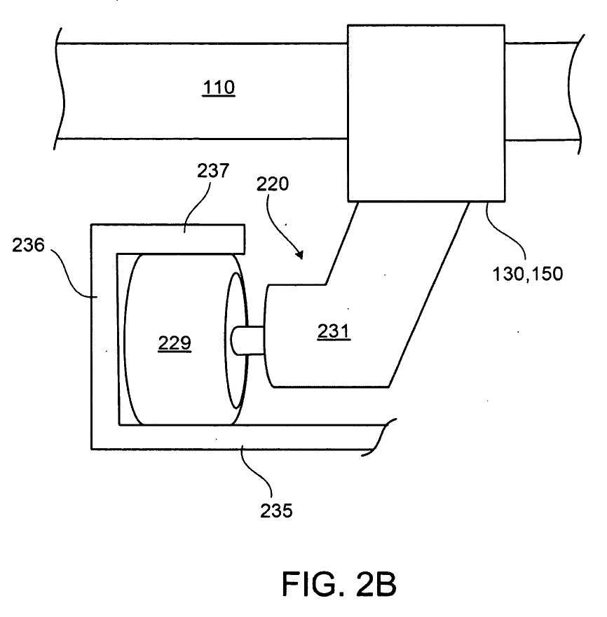

FIG. 2A is a schematic top view of part of a wind turbine.

FIG. 2B is a schematic side view of part of a yaw carriage and bearing ring.

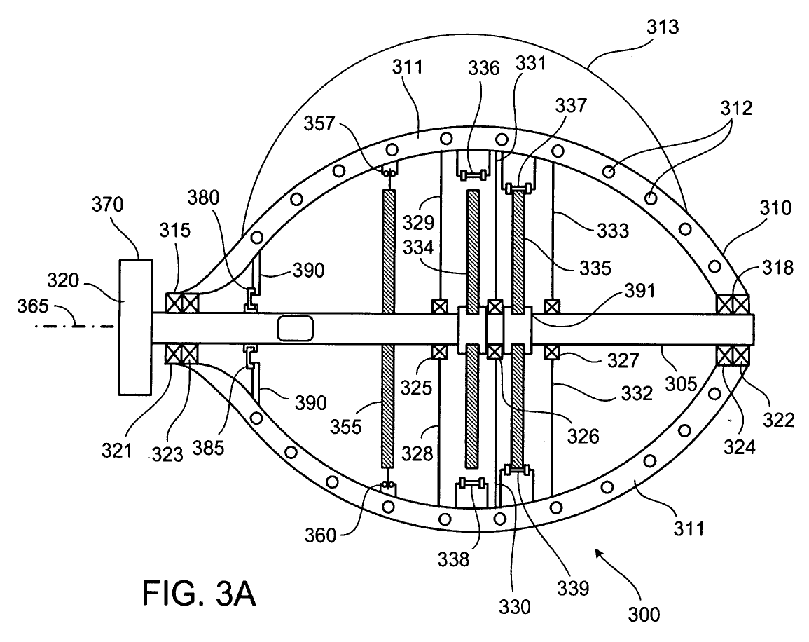

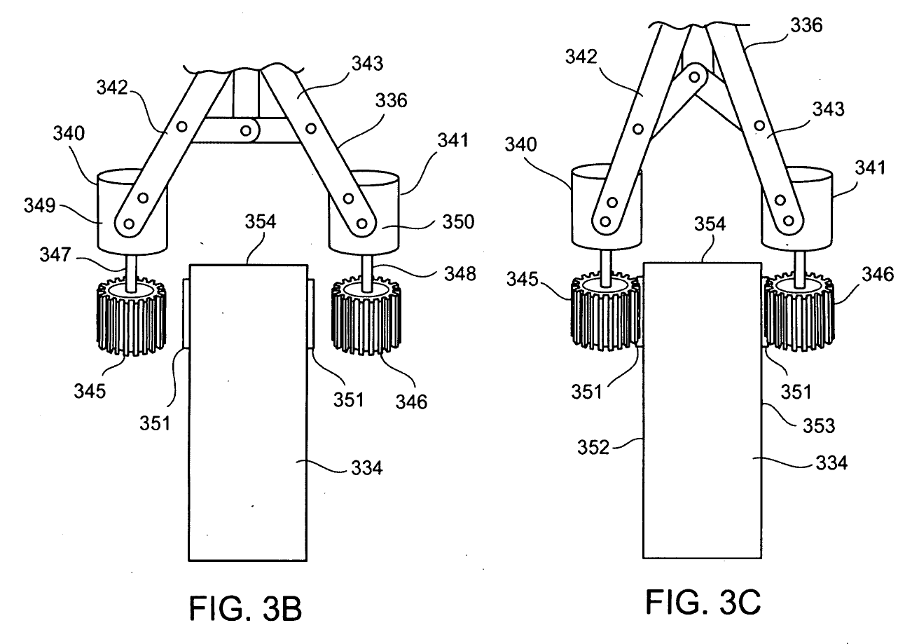

FIG. 3A is a schematic sectional side view of part of a wind turbine.

FIGS. 3B and 3C are schematic side views of part of a generator drive mechanism.

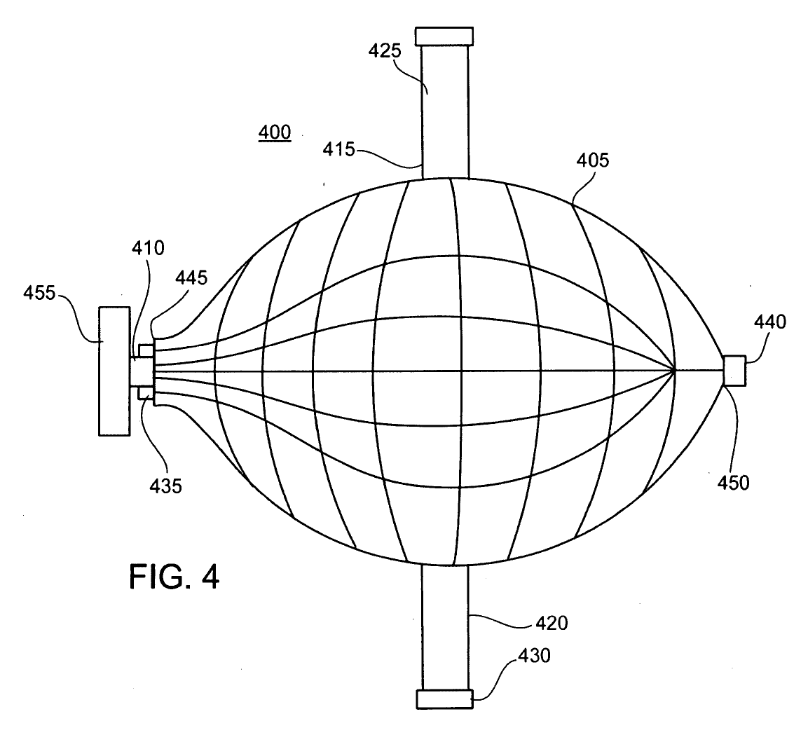

FIG. 4 is a schematic top view of part of a wind turbine.

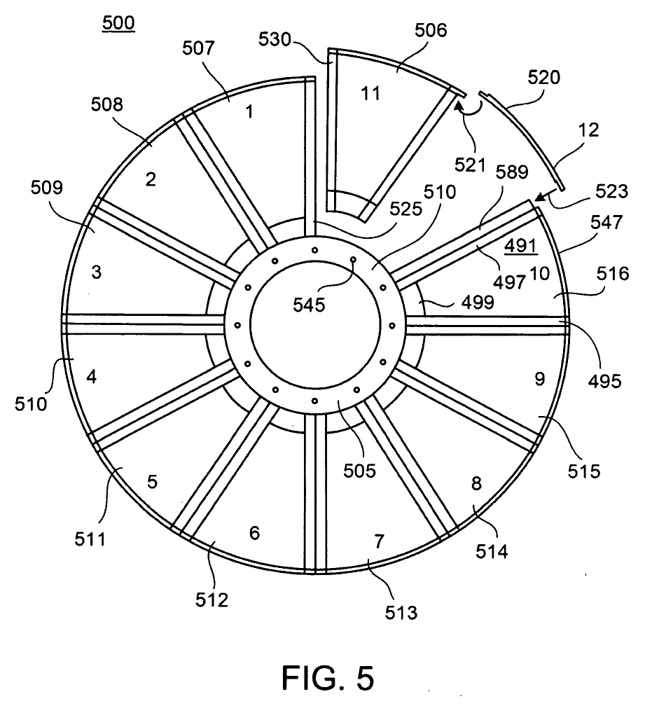

FIG. 5 is a schematic front view of a bull gear.

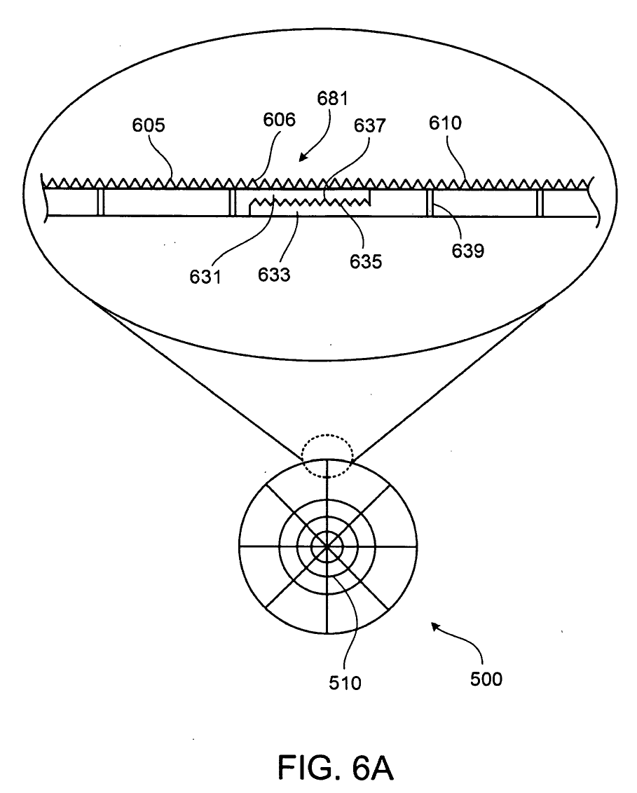

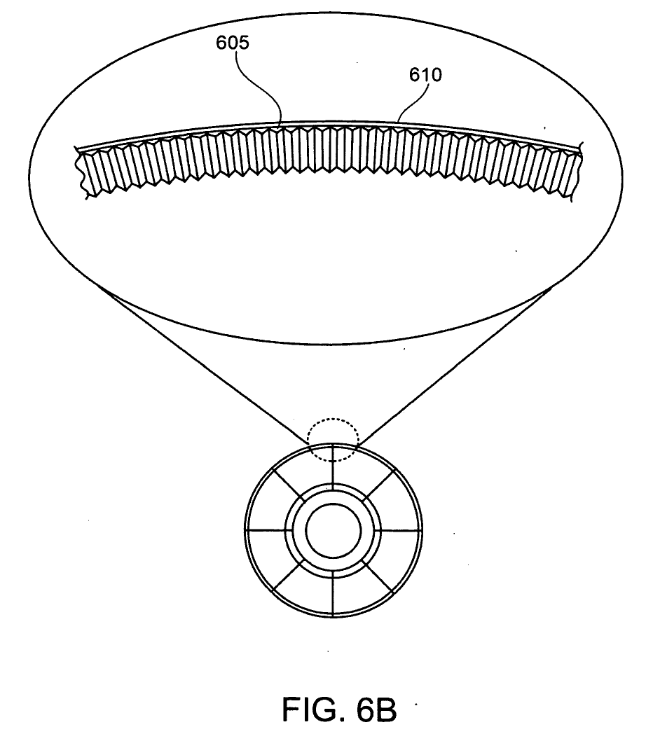

FIG. 6A is a close-up schematic view teeth on a bull gear.

FIG. 6B is a close-up schematic view of teeth on a bull gear.

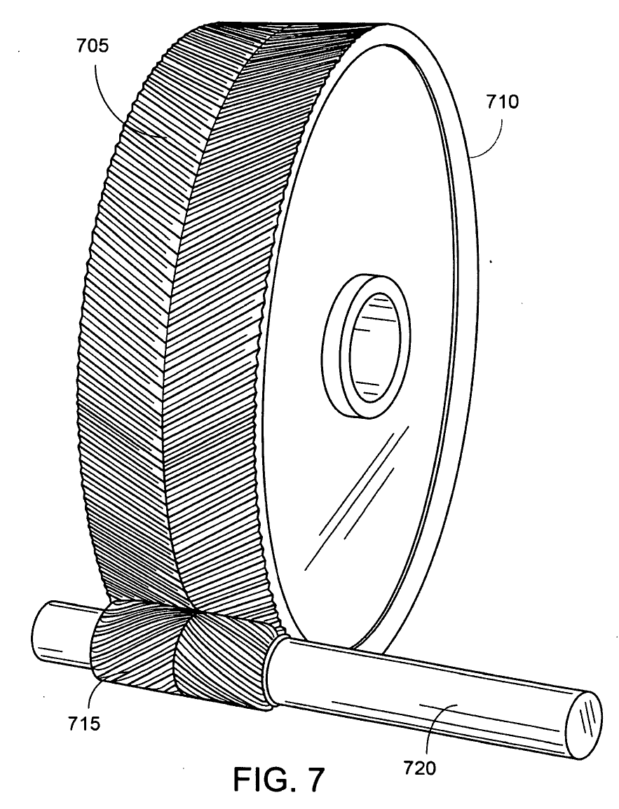

FIG. 7 is a perspective view of a pinion gear.

As shown in FIG. 1, in some examples, a wind-driven power generation device (e.g., a wind turbine to generate electricity) 100 has a rotor 105 connected to a drive shaft 110. The rotor supports two or more rotor blades 115, 120 (not shown to scale) (or one blade that has two ends) that extend away from a rotor hub 125 in a plane 109 that is roughly perpendicular to a rotational axis 111 of the main shaft. Wind 113 against the blades of the rotor drives rotation of the drive shaft 110. The blade or hub can be rigidly fixed to the rotor shaft or mounted on a teeter bearing (not shown) that allows the rotor to pivot or teeter 117 relative to the shaft.

Two axial bearings 130, 135 support opposite ends the drive shaft 110, and restrain, for example, vertical movement of the drive shaft away from its intended axis of rotation. The axial bearings 130, 135 can be metal roller bearings or hydrostatic or hydrodynamic bearings, for example.

Two thrust bearings 150, 155, also support the opposite ends of the drive shaft 110 to resist movement of the drive shaft 110 along the rotational axis as the wind 113 loads and unloads the shaft during operation. In some examples, only one thrust bearing is needed. The thrust bearings 150, 155, may be metal roller or ball bearings or hydrostatic or hydrodynamic bearings, for example.

The main shaft (we sometimes call the drive shaft the “main shaft”) is shown as one piece, but it could be assembled from interlocking, bolted segments. Assembling the shaft from segments makes the shaft easier to transport, and allows for different surface finishes or tolerances along different portions of the shaft, for example, for the portions that are held in bearings. Different segments also can be made of different strengths and sizes of materials, such as the portion 127 of the main shaft that connects to the rotor hub, which bears relatively large bending loads compared to inner segments of the main shaft (between the bearings) that need only bear thrust and torsional loads.

An access portal 151 at an inner location on the main shaft allows workers to pass through the main shaft and beyond the main shaft bearings 130, 150 to access the rotor hub 125 without going outside of the structure.

The shaft and bearings (and other parts of the wind turbine described later) are mounted on a nacelle support 165 of a support tower by a yaw bearing 161 that permits yawing motion 167 about a vertical axis 163 of the support tower. The yaw bearing includes a yaw ring 160 that is supported on the nacelle support 165 and does not move about the vertical axis. The nacelle support and other portions of the support tower are described in another provisional U.S. patent application Ser. No. 61/043,333, and its non-provisional conversion, filed on the same day as this application and entitled “Supporting a Wind-Driven Electric Generator,” (hereinafter the “‘Supporting a Wind-Driven Electric Generator’ patent applications”) both incorporated by reference here in their entirety. Two or more carriages (not shown in FIG. 1) support the nacelle (described later) for rotation on the yaw ring about the vertical axis. Thus, the carriages and the yaw ring together form a yaw bearing. The yaw ring can have rails (like a railroad track) and the carriages can have corresponding wheels that ride on the track. The carriage wheels can include wheels that bear vertically and wheels that bear horizontally on the rails of the track to restrict movement of the carriage both up and down and horizontally. The yaw ring, or the rails of such a track, could bear teeth that mate with teeth on the carriage wheels. The yaw bearing could be a roller or ball bearing slewing ring with the carriages attached to its top. The yaw bearing could be a hydrostatic bearing of the kind described in German DE 102005016156A1, but need not have integral brakes.

Additional details about the support tower (which includes legs 170, 175) are described in the “Supporting a Wind-Driven Electric Generator” United States patent applications. Features described in this application and in the “Supporting a Wind-Driven Electric Generator” patent applications may be combined to achieve a variety of benefits and the combinations may be the subject of claims. As explained here, in some examples, the yaw ring is mounted on the top of the nacelle support, and the main shaft, rotor, generators, and nacelle housing (described later) are supported by carriages on the yaw ring to permit yawing (or other slewing). The rotor hub is mounted on the end of the main shaft only a short distance from the nearest shaft support bearing.

The nacelle support of the support tower, for example, as shown in the “Supporting a Wind-Driven Electric Generator” patent applications, is broader at the top and narrow at the bottom where it forms a waist of the support tower. This configuration provides a relatively broad support for a relatively large diameter yaw ring and a clear space 171 within which the rotor blades 115, 120 may flex and the rotor teeter without striking the support tower 165. The rotor hub 125 also can be mounted no more than a short distance 127 from the axial bearing 130 which reduces the length of the lever arm on which the weight of the rotor acts. As a result, the rotor blades can be relatively large and heavy, the axial bearing (and other bearings) may be relatively lighter and less costly, or some combination of the two. Generally, rotor blades 150, 155 that are longer or have greater surface area will catch more wind and produce more electricity. In some examples, the diameter of the yaw ring 160 and the corresponding weight will be large enough to require yaw ring braces 180, 185 to cooperate with and supplement the support provided by tower legs 170, 175.

As shown in FIG. 2A, in some implementations, one or more wheels (e.g., bull gears 210, 215) are mounted concentrically on the main shaft 205. The main shaft is closer to the horizontal plane of the yaw ring (distance 169 in FIG. 1) than the radius of the largest of the bull gears, so that the bull gear intersects the plane of the yaw ring. This placement of the bull gear lowers the center of gravity of the nacelle (compared to an arrangement in which the main shaft and the bull gears were located completely above the plane of the yaw ring) and reduces vertical and torsional forces on the yaw bearing. The arrangement also allows generators (not shown in FIG. 2A) to be connected to the nacelle circularly all around the periphery of the wheel or bull gear, so that the torsional forces from the generators pass directly to the nacelle support of the tower through a shorter load path.

As mentioned earlier and as shown in FIG. 2A, in addition to the axial and thrust bearings at the ends of the main shaft 205, yaw carriages 220, 225 may also be provided underneath the thrust and axial bearings 130, 135 to support the main shaft 205 and the rotor 230 on the yaw ring 235. The term yaw carriage includes any possible kind of support that transfers the weight and loads of the nacelle onto the circular yaw ring through a slewing (e.g., yaw) bearing. The bearing between the carriage and the yaw ring can be of any kind including ball bearings, roller bearings, or slide bearings, wheels or other rotating devices or combinations of them, among other approaches. This enables the main shaft 205 to rotate 360 degrees around the vertical axis of the tower and permit the axis of the rotor 230 to be aligned with the direction of the wind.

In some implementations, the axis of the main shaft need not intersect the vertical axis of the support tower, but may be laterally offset, for example, as described in U.S. Pat. No. 4,353,681.

In some implementations, one or two or more additional yaw carriages 221, 227 can also support the nacelle. All of the carriages can be spaced around the vertical axis of the tower at equal intervals, or another arrangement can be used.

The yaw carriages may include roller, ball, slide, or bearings, hydrostatic bearings, or wheels, or gears, for example. The electric generators or other devices (not shown in FIG. 2A) can be used to draw power either mechanically or electrically from the rotation of the main shaft for a variety of uses within the support tower, nacelle, or rotor, for example, to power controls, motors, and equipment including to drive, brake, and control the yawing of the nacelle.

All of the moving parts of the wind-driven generator, except the rotor, parts of the nacelle housing and a short extension of the main shaft to receive the rotor, lie within an imaginary vertical cylinder centered on the yaw axis and having a diameter equal to the external diameter 259 of the yaw ring.

Two of the yaw carriages support the main shaft on the yaw ring at locations that are 180 degrees apart. In some implementations, at least two of the yaw carriages that support the main shaft are located at positions less than 180 degrees apart on the yaw ring.

Additional main shaft bearings 240, 245, 250 may be mounted along the main shaft and may bear structural elements 241, 243, 247 (shown only partially in FIG. 2A) that are connected to and provide structural strength and support for the main shaft from a nacelle housing (not shown in FIG. 2A) The number and location of the nacelle bearings can be different from those shown.

In FIG. 2B, an example of a yaw ring 235 includes horizontal 236 and vertical 237 supports to form a track for the yaw carriages. The carriages are held in the track to prevent the nacelle from moving horizontally from its intended location as it yaws and from rising vertically away from the yaw ring as a result of torques and forces that are applied to the main shaft as the wind loads and unloads the rotor blades.

The carriage 220 can include a support 231 and a wheel 229 mounted on the support and arranged to ride within the track of the yaw ring. In other arrangements, the support can hold at least one wheel mounted on a vertical axis to ride on the horizontal support 236 and at least one wheel mounted on a horizontal axis to ride on the vertical support 237 and the ring 235.

As shown in FIG. 3A, the nacelle 300 (in our use of the term) includes all of the parts of the wind turbine that can yaw around the vertical axis of the support tower, except for the rotor. In the example shown in FIG. 3A, the nacelle includes, among other things, the main shaft 305, and a nacelle housing 310 that includes a lattice of beams 311 and cross-members 312, and a light-weight covering for the lattice structure to form an outer surface of the nacelle 300.

In some implementations, the beams 311 and cross-members 312 are i-beams or tubular sections and the covering is metal sheeting, fiberglass panels, fabric, or a combination of them.

The lattice structure has an aerodynamic-shape to reduce wind resistance, for example, pear-shaped, with the narrow end of the “pear” closer to the rotor, or an aerodynamic tear-drop shape, with a narrower end than the pear.

Opposite ends of the nacelle housing have openings 315, 318 to accommodate the main shaft 305. The axial and thrust shaft bearings 321, 322, 323, 324 are rigidly connected to the nacelle housing 310 to support the main shaft 305 and keep it balanced and aligned during operation. As explained earlier, additional support may be provided by shaft bearings 325, 326, 327 and related structural elements (cables or rods 328, 329, 330, 331, 332, 333, for example) that connect those bearings rigidly to the lattice of the nacelle housing.

In the example of FIG. 3A, the two bull gears (wheels) 334, 335 drive two sets of electric generator units (e.g., generator pairs), one set 336 and 338 arranged around one of the bull gears, and the other set 337, 339 arranged around the other bull gear. The generator units are attached to the lattice structure of the nacelle 310 so that when the main shaft is turning the generators are driven against the resistance of the relatively fixed nacelle.

In the example shown in FIG. 3A, each of the generator units includes two generators connected by a common pinion shaft that bears a gear wheel. The generators can be relatively small, low-cost generators and the number of generators can be relatively high (for example, any number from one or two per bull gear to dozens or even hundreds of generators). In some implementations there are more than 50 generators in total. In some implementations there are at least 9 generators. Some or all of the generator units 336, 337, 338, 339 can be mounted on the nacelle housing lattice structure using supports that enable each of the generator units to be independently swung from a retracted position in which the common shaft is released from engagement with one of the bull gears to an engaged position in which the common shaft (or a gear on it) is engaged with (and driven by) one of the corresponding bull gears 334, 335.

The gear on each common shaft could be a pinion gear. Other approaches could be used to independently engage and disengage each of the generator units 336, 337, 338, 339 mechanically or electrically or both from the bull gears 334, 335. The shaft connecting the pinion gear to the generator or generators may have an elastic or spring mechanism that absorbs some of the torque ripple of the generator and reduces the peak forces and thus wear between the generator pinion gear teeth and the wheel gear teeth.

Controllers and control mechanisms are provided to synchronize rotational speeds and selectively engage and disengage some combination of the generator units 336, 337, 338, 339 with the bull gears 334, 335. In some examples, the pinion gears of the generator units can remain continually in place against the bull gear or wheel and the generator units can be engaged and disengaged using a clutch mechanism on the pinion shaft or other technique.

In order to simplify the engagement and disengagement of multiple generators, a clutch or other mechanism 391 may be used to engage and disengage the entire bull gear at the main shaft, while leaving the generators engaged at the periphery of the bull gear. This allows each of multiple bull gears to be engaged and disengaged selectively so that the overall torque and power of the engaged generators can be arranged to match that the power provided by the wind.

Among other things, this arrangement of generator units, bull gears, controllers, and engagement mechanisms enables one or more of the generator units 336, 337, 338, 339 selectively to be used to generate electricity during rotation of the main shaft depending on a wide variety of circumstances and conditions.

For example, all of the generator units 336, 337, 338, 339, could be engaged during high, steady wind conditions, to maximize electric power generation. In low wind conditions, some of the generator units could be disengaged to reduce the total resistance to rotation of the main shaft that is imposed by the generator units. Generator units could be selectively engaged and disengaged to help control the speed of the rotor 320 or control the electrical output of the device. The number of generator units 336, 337, 338, 339 that are engaged with the bull gears and/or the number of bull gears engaged with the main shaft can be changed dynamically to match, for example, the wind force acting on the rotor.

The engagement and disengagement of the generators can be controlled by a person or a computer or a combination of them based on a wide variety of factors and data, including information about wind speed, rotor pitch position, main shaft rotational speed, power load, and efficiency of the generator units, among others.

Any number of generator units may be attached to the nacelle housing around only a portion or around the entire circumference of each bull gear, depending on the size of the generator units, the number of bull gears, and the inner circumference of the nacelle housing. The generator units may be evenly spaced around the bull gear, or spaced in other ways.

In some implementations, the generator units and the generators used in them are relatively small, capable of inexpensive and large-scale production and simple maintenance and replacement. Not all of the generators used in a given nacelle need to be identical. They can be produced by more than one manufacturer and can have various electromechanical characteristics. The power rating of each of the generators can be small, for example as small 200 kilowatts (or even smaller), yet the total power rating of the wind turbine can be 1 megawatt or higher.

In addition to enabling dynamic control of the electricity generating capabilities of the wind turbine, the use of multiple generators that can be engaged and disengaged independently and selectively also makes it easy, relatively inexpensive, and not disruptive of normal operation, to remove broken generators, replace old generators, repair and maintain individual generators, install additional generators, and increase or decrease the total number of generators in the nacelle housing.

In some implementations, heat generated by the generator units can be vented to the atmosphere outside the nacelle housing through heat conducting pathways provided from the generators through the mounting structures, and through the nacelle housing to cooling fins 313 mounted on the lattice structure. Other venting mechanisms could also be employed, for example filtered venting holes provided in the outside surface of the nacelle 310 at respective positions of high and low external air pressure to induce cooling airflow past the generator units.

As shown in FIG. 3B, in some implementations, instead of the two generators of a generator unit sharing a common shaft (parallel to the main shaft) bearing a pinion gear to engage teeth on the outer peripheral surface of the bull gear, two pinion gears 345, 346 are attached (perpendicular to the main shaft) to generator shafts 347, 348 which extend into the corresponding generator housings 349, 350. Two swinging support arms 342, 343, connect the housings to an engagement mechanism. In one position of the engagement mechanism, shown in FIG. 3B, the pinion gears are disengaged.

Each generator housing 349, 350 may enclose a permanent magnet generator, induction generator, switched reluctance generator, hydraulic generator, or other power generation device capable of engaging a bull gear or other wheel 334 and generating power.

In the engaged position (FIG. 3C), the engagement mechanism releases the swinging support members 342, 343 allowing the pinion gears 345, 346 of the generators to engage teeth 351 on the sides 352 and 353 faces of the bull gear 334. The rotating bull gear 334 applies a torque to and rotates the pinion gears 345, 346 to generate electricity. The electricity is conducted from the generators to electric transmission wires that may be run along the lattice structure and combined for transmission from the nacelle to rectifiers and grid inverters, or transformers and then to the power grid. The electrical transmission lines may run from the nacelle to the foot of the tower either inside or outside of the tower legs.

The generator unit arrangement of FIGS. 3B and 3C allows for a high degree of tolerance between the engagement of the generators 340, 341 and the bull gear 334. The swinging support members 342, 343 allow the pinion gears 345, 346 of the generators 340, 341 to float when engaging and engaged with the bull gear 330. For example, a spring mechanism between the swinging support members 342, 343 can permit temporary disengagement of the pinion gears 345, 346 as needed to accommodate damaged bull gear teeth 351, misalignment of the orbit or rotation of the bull gear 334, or other non-uniformities.

The pinions 345, 346 may rotate independently of each other and need not be pre-aligned with the teeth 351, 352 of the bull gear 334. The precision of the bull gear 334 and the pinions 345, 346 need not be high. For example, the bull gear 334 can be out of rotational alignment with the pinions 345, 346 by a few percent, because the pinions 345, 346 are capable of floating and accommodating deviations from exact alignment with the bull gear teeth 351. In configurations (such as the ones described earlier), in which the generators engage the bull gear 334 on its outer surface 354, floating pinion gears would allow proper operation and continuous engagement of the pinion gears with the bull gear teeth even if the bull gear is not perfectly circular. By avoiding some of the required precision and structural supports of planetary gear configurations the nacelle components can be more efficiently manufactured, designed, and maintained.

For controlled braking of rotation, a brake disk 355 (FIG. 3A), concentrically attached to the main shaft 305, cooperates with braking mechanisms 357, 360 attached to the nacelle lattice structure to apply a frictional or other force to the brake disk 355 to reduce or stop rotation of the main shaft 305. Any number of braking mechanisms 357, 360 may be provided. The braking mechanisms 357, 360 may be traditional spring loaded or hydraulically-controlled calipers that depress, engaging the brake disk, or other devices. The braking mechanisms 357, 360 may draw power from one or more of the generator units. The large diameter of the brake increases the relative speed of the disk and the calipers as compared to a conventional smaller diameter rotor shaft brake, thereby increasing the braking power. Controls for engaging the braking mechanisms 357, 360 can, for example, be synchronized with or supplement control of the braking mechanisms 357, 360 with control of the engagement of the generator units 336, 337, 338, 339. The brake disk may have holes to receive removable rods to lock the rotor in a fixed position during shutdown or repair.

The rotor 320 has a rotor hub 365 with rotor flanges 370 to which rotor blades can be attached. The rotor hub 365 and flanges 370 can be controlled to adjust the pitch of the rotor blades based on, for example, pitch measurement and the capabilities of the pitch control equipment. Control systems not related to rotor blade pitch adjustment may also be provided, such as wind speed, air pressure, and rotor velocity monitors.

Power for rotor blade pitch adjustment, generator engagement equipment, control systems, and other systems in the nacelle can be produced by generators 380, 385 attached to and rotating with the main shaft. The main shaft generators may be electric generators, hydraulic pumps, pneumatic pumps or any other power generation device, for example, an electrical generator 380 and a hydraulic pump 385. Each of the devices 380, 385 may include a pinion gear driving an inductive, magnetic, or any other type of electrical generator, pneumatic, or hydraulic pump. Rotation of the pinion gear may be aided by communication with a fixed gear 390 mounted on the nacelle housing.

The powered system can provide power to change the pitch of the blades connected to the rotor, for lights on the blades, or for sensors in the rotor hub and/or blades. The pneumatic pump can provide pressurized air which can be used to alter the aerodynamic characteristics of the blades.

In some implementations, the teeth of the gear 390 are arranged on a face to engage with the pinion gears of generators 380, 385. While two generators 380, 385 and a single gear 390 are shown in FIG. 3A, any number of shaft-driven generators and nacelle-mounted gears may be provided to supply power to the rotor hub systems. The generators 380, 385 rotate with the shaft 305 and around the stationary gear 390, the teeth of the generators' pinion gears engaging the teeth of the gear 390 as the pinion gears proceed around the circumference of the gear 390. The resulting rotation of the pinion gears generates power in the generators 380, 385. The power generated is transmitted by electric and hydraulic transmission lines located within the shaft 305 to the rotor hub 365. Given that the rotor 320 is attached to the shaft 305 and through the shaft to the bull gear and also to the generators 380, 385, the generators and the transmission lines rotate together with the rotor 325 to allow power to be transmitted without a slip ring.

In the example view 400 shown in FIG. 4, a nacelle 405 includes a main shaft 410, power generation components, and nacelle support beams 415, 420 that ride around the yaw ring on yaw carriages 425, 430. Yaw carriages 435, 440, at or near the shaft openings 445, 450 help to support the nacelle 405, shaft 410, and rotor 455 on the yaw ring. Fewer than four yaw carriages could be used, for example, three yaw carriages at 120 degree intervals around the yaw ring, two at the ends of the support beams 415, 420, and the third near the nacelle opening 445.

The bull gears are scalable to accommodate design constraints and performance needs of a given wind turbine, for example, one that has large rotor blades to harness more wind energy. The larger the diameter of the bull gear, the longer the circumference of the bull gear, thereby allowing a greater number of power generation units to be positioned about the circumference of the bull gear. The rotor may have any number of blades, can be of the upwind or downwind variety, and may teeter or not.

By using a large diameter bull gear on the main shaft and driving generators at the outer periphery of the bull gear, a large speed change can be achieved in a single gear stage. For example, the speed of rotation of the generator shafts can be up to 50 times the speed of rotation of the main shaft or more, a speedup that is achieved in only a single gear stage. Even larger speed changes can be achieved.

The generators can be driven directly by the pinion gears or there can be additional gear stages for each generator or pair of generators to increase the speed of the generators further. Unlike typical geared wind turbines, the pinion gear for a given generator unit does not have to accept the entire torque generated by the rotor, but only the rotor torque divided by the number of generator units being driven. For example, a 5 megawatt turbine with 200 pinions can have gears that are each sized to 25 kilowatt generators, far less than the power in a car, for example.

Low cost materials and manufacturing methods can be used. The potentially large number of generators required per wind turbine enables lower cost high volume manufacturing methods. At higher wind levels, the availability of more generator units that can be engaged with the bull gears yields greater power-generation capacity. The length and number of rotor blades and the diameter of the bull gear will affect the design because, as the diameter of the bull gear increases, so too does the potential speedup gear ratio between the main shaft and generators.

Because of the greater potential capacity for power generation, bull gears larger than ten meters in diameter may be useful. To make a large bull gear economically transportable to the erection site, the gear could be made and shipped in pieces and assembled at the site.

As shown in FIG. 5, a central hub 505 (e.g., a steel casting) of a bull gear 500 is formed with flanges 510 to enable the hub to be bolted to a portion of the main shaft to accept, e.g., eleven identical bull gear segments 506-516. Each of the segments 506-516 has an inner piece 499 that is bolted to the hub, two radial arms 497, 495 that extend from the inner piece to the periphery of the bull gear, and a pie-shaped filler piece 491 between the two radial arms. The radial arms of adjacent segments may interlock or mate (e.g., arms 525 and 530). Each of the segments 506-509, 511-516 can be cast steel that is machined and bolted to the hub.

During manufacture, the segments 506-509, 511-516 are temporarily bolted to the flanges 510 through holes 545. After assembly, the wheel can be laid horizontal with the hub on a bearing to permit the wheel to be rotated around a vertical axis and past a milling machine located at the periphery of the wheel. As the wheel is rotated the milling machine mills the outer periphery 547 to be an exact round shape of a desired dimension. Before the wheel is disassembled for shipment to the site, gear teeth sections can be temporarily fitted to the milled outer periphery.

As shown in FIG. 6A, each of the gear teeth sections 605, 610 is made of a thin segment of high quality gear steel curved to match the outer periphery of the bull gear. (The curvature is not apparent in the FIG. 6A.) Each gear teeth section 605, 610 has stepped ends 631, 633 that bear interlocking keys 635, 637. Teeth 606 are machined on the outer surface of the section while the segments are interlocked to assure that when reassembled at the site, the bull gear teeth will have the intended orientations, pitches and continuity around the bull gear. Each gear teeth section is bolted to the outer periphery of the bull gear through bolt holes 639.

The machined bull gear and gear teeth sections are then disassembled so that the bull segments and teeth sections can be shipped individually. At the site, the bull gear is reassembled. The bull gear can be assembled on the ground and hoisted to the top of the nacelle support, or the pieces can be hoisted and assembled at the top of the nacelle support.

Because of the interlocking arrangement of adjacent gear teeth sections, before the twelfth segment of the bull gear (not shown in FIG. 5) is mounted on the hub, a twelfth gear teeth section 520 is attached by interlocking (523) its step 631 on one end to the corresponding step on an adjacent gear teeth section. Next the other end of the gear teeth section is moved (521) radially in toward the hub and under the interlocking teeth of the other adjacent gear teeth section and then radially outward to interlock. Once the section 520 is in place, the twelfth segment of the bull gear can be installed on the wheel, and the gear teeth section bolted to the twelfth segment.

In this way, gear teeth sections that become worn or damaged can be easily replaced a section at a time, without replacing other sections or any of the segments of the bull gear, which saves time and money.

In some implementations, as shown in FIG. 6B, the gear teeth sections can be machined radially rather than axially and mounted at or near the outer periphery of one or both faces of the bull gear. These sections can be interlocked either as shown in FIG. 6B or with the interlocking keys on the plane of the bull gear.

In some implementations, the bull gear teeth 705 (FIG. 7) could be machined in a herringbone pattern on a bull gear 710 for mating with corresponding teeth 715 on a pinion gear 720 of a generator unit. Angled gear teeth engage more smoothly and the use of two teeth sequences in a herringbone pattern balances any net force along the axis of the pinion that might otherwise be caused by angled gear teeth.

Other implementations are also within the scope of the claims.

1. An apparatus for use in wind-driven generation of electricity comprising
a main shaft to be rotated by a wind-driven rotor,
a wheel having a diameter of at least 5 meters and mounted to rotate with the main shaft,
an electrical generator to be driven by the wheel, and
a yaw ring defining a plane around which the main shaft and rotor yaw, the wheel intersecting the plane of the yaw ring.

2. The apparatus of claim 1 also including gear teeth that directly engage to cause the electrical generator to be driven by the wheel.

3. The apparatus of claim 1 in which there are at least nine electrical generators to be driven by the wheel.

4. The apparatus of claim 3 in which the apparatus can generate at least one megawatt, and the average power of the generators is less than 200 kilowatts.

5. The apparatus of claim 1 also including at least one other wheel mounted to rotate with the shaft, and another electrical generator to be driven by the other wheel.

6. The apparatus of claim 1 also including a braking disk mounted to rotate with the main shaft.

7. The apparatus of claim 6 also including a brake mounted stationary relative to the main shaft and configured to engage the braking disk.

8. The apparatus of claim 1 in which there are at least 50 generators to be driven by the wheel.

9. The apparatus of claim 1 in which a speedup ratio between the main shaft and the generator is at least 50 in a single speedup stage.

10. The apparatus of claim 1 also including bearings to support the main shaft.

11. The apparatus of claim 10 in which there are at least 3 bearings to support the main shaft.

12. The apparatus of claim 11 in which the largest distance between two bearings along the main shaft is at least 10 meters.

13. The apparatus of claim 1 also including at least two carriages to support the main shaft on the yaw ring and permit the main shaft to yaw about a vertical axis.

14. The apparatus of claim 13 in which the wheel and the generator lie completely within an imaginary vertical cylinder that is centered on the vertical axis and has a diameter equal to an outer diameter of the yaw ring.

15. The apparatus of claim 13 in which the yaw ring diameter is at least 10 meters.

16. The apparatus of claim 13 in which the yaw ring has a diameter of at least 5 meters.

17. The apparatus of claim 1 in which the main shaft has an access portal to allow a person to pass through the main shaft to a hub of the wind-driven rotor.

18. The apparatus of claim 13 also including a nacelle structure and two additional carriages to support the nacelle structure on the yaw ring.

19. The apparatus of claim 13 in which the yaw carriages include wheels to engage the yaw ring.

20. The apparatus of claim 13 in which the yaw ring includes structure to restrain vertical movement of the carriages relative to the yaw ring.

21. The apparatus of claim 13 in which the yaw ring includes structure to restrain horizontal movement of the carriages.

22. The apparatus of claim 13 also including a nacelle structure that encloses the main shaft and the generator.

23. The apparatus of claim 22 in which the nacelle structure comprises a lattice.

24. The apparatus of claim 23 also including a lightweight covering on the lattice.

25. An apparatus for use in wind-driven generation of electricity, the apparatus comprising
a bull gear to be mounted on a shaft to be driven by a bladed rotor,
the bull gear comprising segments that can be disassembled for shipment and reassembled for installation,
the bull gear having gear teeth at its periphery to directly drive at least one electric generator with no intervening gear stages.

26. The apparatus of claim 25 in which the diameter of the bull gear is at least 5 meters.

27. The apparatus of claim 25 in which the teeth are on an outer peripheral surface of the bull gear that is parallel to the shaft.

28. The apparatus of claim 25 in which the teeth are on a surface of the bull gear that is perpendicular to the main shaft.

29. The apparatus of claim 25 also including a pinion gear associated with the electric generator and having teeth to be driven directly by the gear teeth of the bull gear.

30. The apparatus of claim 29 in which the interface between the pinion gear and generator includes a resilient element to absorb torque ripple of the generator and reduce teeth wear.

31. The apparatus of claim 29 in which the pinion gear drives at least one other generator.

32. The apparatus of claim 25 also including a mechanism to selectively disengage the generator from being driven by the wheel.

33. The apparatus of claim 32 in which the mechanism comprises a clutch.

34. The apparatus of claim 32 in which the mechanism is operated electrically.

35. The apparatus of claim 32 in which the mechanism is operated hydraulically.

36. The apparatus of claim 25 in which the bull gear achieves a speed-up ratio in one gear stage of at least 50 from rotation of the shaft driven by the bladed rotor to rotation of a shaft of the generator.

37. The apparatus of claims 25 in which the gear teeth are formed on sections that can be disassembled for shipment and reassembled for installation.

38. The apparatus of claim 25 in which the gear teeth sections include features to interlock the teeth sections when they are mounted on the bull gear.

39. A method for use in wind-driven generation of electricity, the method comprising:
temporarily assembling a bull gear from segments,
machining an outer periphery of the temporarily assembled bull gear to be circular and continuous,
disassembling the segments for shipment to a wind tower site,
reassembling the segments at the site, and
attaching gear teeth sections on the bull gear during reassembly.

40. The method of claim 39 in which attaching the gear teeth sections during reassembly includes attaching a final gear teeth section to the bull gear before a final one of the bull gear segments is installed.

41. The method of claim 39 in which the each gear teeth section has interlocking features to interlock adjacent gear teeth sections when they are mounted on the bull gear.

42. An apparatus for use in wind-driven generation of electricity comprising
a main shaft that is supported between at least two bearings and has an end that extends beyond one of the bearings to be driven by a bladed rotor,
a power generator mounted to the main shaft and rotates with it to drive the power generator, and
a nacelle holding the main shaft and power generator,
the power generator being driven by the main shaft against a mechanism that is stationary with respect to a nacelle, and
power transmission lines connecting the power generator to a powered system within the bladed rotor without requiring a slip ring or similar device.

43. The apparatus of claim 42 in which the power generator includes an electrical generator or a hydraulic or pneumatic pump.

44. The apparatus of claim 42 in which the power transmission lines are at least partly within the main shaft.

45. The apparatus of claim 42 in which the powered system adjusts a pitch of a blade connected to the rotor, or powers lights on the blades, or powers sensors on the hub or the blades.

46. An apparatus for use in wind-driven generation of electricity comprising
a main shaft to be rotated by a wind-driven rotor,
a main wheel mounted to rotate with the main shaft,
an electrical generator,
the generator shaft including a feature that engages the main wheel to drive the generator,
the ratio of the diameter of the main wheel to the diameter of the feature of the generator shaft being 50 or greater.

47. The apparatus of claim 46 in which the feature of the generator shaft comprises a generator wheel.

48. The apparatus of claim 46 in which the feature of the generator shaft includes gear teeth to engage gear teeth at a periphery of the main wheel.

49. The apparatus of claim 46 in which there are at least nine electrical generators to be driven by the main wheel.

50. The apparatus of claim 49 in which the apparatus can generate at least one megawatt, and the average power of the generators is less than 200 kilowatts.

51. The apparatus of claim 46 also including at least one other wheel mounted to rotate with the shaft, and another electrical generator to be driven by the other wheel.

52. The apparatus of claim 46 also including a mechanism to selectively decouple the main wheel from rotation with the main shaft.

53. The apparatus of claim 46 in which the diameter of the main wheel is at least 5 meters.

54. The apparatus of claim 46 in which there are at least 50 generators to be driven by the main wheel.

55. The apparatus of claim 46 also including at least two carriages to support the main shaft on a yaw ring and permit the main shaft to yaw about a vertical axis and in which the main wheel and the generator lie completely within an imaginary vertical cylinder that is centered on the vertical axis and has a diameter equal to an outer diameter of the yaw ring.

56. The apparatus of claim 46 in which the yaw ring has a diameter of at least 5 meters.

57. An apparatus for use in wind-driven generation of electricity comprising
a main shaft to be rotated by a wind-driven rotor,
a wheel mounted to rotate with the main shaft at a location separate from a hub of the rotor,
an electrical generator to be driven by the wheel, and
a mechanism to selectively decouple the wheel from rotation with the main shaft.

58. The apparatus of claim 57 in which the diameter of the wheel is at least 5 meters.

59. The apparatus of claim 57 in which there are at least nine electrical generators to be driven by the wheel.

60. The apparatus of claim 57 in which a drive shaft of the generator is perpendicular to the main shaft.

61. The apparatus of claim 57 in which a drive shaft of the generator is parallel with the main shaft.

62. The apparatus of claim 57 in which the drive shaft of the generator includes a pinion gear to be driven by the wheel.

63. The apparatus of claim 57 in which the apparatus can generate at least one megawatt, and includes multiple generators having an average power less than 200 kilowatts.

64. The apparatus of claim 63 in which there are at least 50 generators.

65. The apparatus of claim 57 also including at least one other wheel mounted to rotate with the shaft, and another electrical generator to be driven by the other wheel.

66. The apparatus of claim 57 in which the mechanism to selectively decouple the wheel from rotation with the main shaft comprises a clutch.

67. The apparatus of claim 57 in which the diameter of the wheel is at least 10 meters.

68. The apparatus of claim 57 in which a speedup ratio between the main shaft and the generator is at least 50 in a single speedup stage.

69. The apparatus of claim 57 also including bearings to support the main shaft.

70. The apparatus of claim 69 in which the largest distance between two bearings along the main shaft is at least 10 meters.

71. The apparatus of claim 57 also including at least two carriages to support the main shaft on a yaw ring and permit the main shaft to yaw about a vertical axis.

72. The apparatus of claim 71 in which the wheel and the generator lie completely within an imaginary vertical cylinder that is centered on the vertical axis and has a diameter equal to an outer diameter of the yaw ring.

73. The apparatus of claim 71 in which the yaw ring has a diameter of at least 5 meters.

74. The apparatus of claim 71 also including a nacelle structure and two additional carriages to support the nacelle structure on the yaw ring.

75. The apparatus of claim 71 in which the yaw carriages include wheels to engage the yaw ring.

76. The apparatus of claim 71 in which the yaw ring includes structure to restrain vertical movement of the carriages relative to the yaw ring.

77. The apparatus of claim 71 in which the yaw ring includes structure to restrain horizontal movement of the carriages.

78. The apparatus of claim 57 also including a nacelle structure that encloses the main shaft and the generator.

79. An apparatus for use in wind-driven power generation comprising
at least three legs that define a lower tower that is relatively broad at its lower end and rises to a relatively narrow waist,
a nacelle support that is relatively narrow at its lower end where it is attached to the waist and relatively broader at its upper end where it supports the nacelle,
a main shaft to be rotated by a wind-driven rotor,
a wheel mounted to rotate with the main shaft at a location separate from a hub of the rotor,
an electrical generator to be driven by the wheel, and
a yaw ring on the nacelle support, the yaw ring defining a plane around which the main shaft and rotor yaw, the wheel intersecting the plane of the yaw ring.

80. The apparatus of claim 79 also including a mechanism to selectively decouple the wheel from rotation with the main shaft.

81. The apparatus of claim 79 in which the electrical generator includes a shaft that has a feature that engages the main wheel to drive the generator, the ratio of the diameter of the main wheel to the diameter of the feature of the generator shaft being 50 or greater.

82. The apparatus of claim 79 in which the main shaft is supported between at least two bearings and has an end that extends beyond one of the bearings to be driven by the rotor.

83. The apparatus of claim 79 also including a nacelle on the nacelle support, the nacelle holding the main shaft and power generator.

84. The apparatus of claim 79 also including power transmission lines connecting the generator to a powered system within the rotor without requiring a slip ring or similar device.

85. The apparatus of claim 79 in which the wheel includes segments that can be disassembled for shipment and reassembled for installation.

86. The apparatus of claim 5 in which there are at least 25 generators to be driven by the wheel and at least 25 other generators to be driven by the other wheel.

87. The apparatus of claim 25 further comprising:
at least one other bull gear to be mounted on the shaft and comprising
segments that can be disassembled for shipment and reassembled for installation, and gear teeth at its periphery to directly drive at least one electric generator with no intervening gear stages.

88. The apparatus of claim 46 further comprising:
at least one other wheel mounted to rotate with the main shaft.

89. The apparatus of claim 57 further comprising:
at least one other wheel mounted to rotate with the main shaft at a location separate from a hub of the rotor.

90. The apparatus of claim 79 further comprising:
at least one other wheel mounted to rotate with the main shaft at a location separate from a hub of the rotor.
